(19) United States
(12) Patent Application Publication
(10) Pub. No.: US 2020/0337494 A1
(43) Pub. Date: Oct. 29, 2020

(54) Portable Baby Food Warmer

(71) Applicant: Digital Heat Technology Ltd., Hong Kong (CN)

(72) Inventor: Nam TSUI, Hong Kong (CN)

(21) Appl. No.: 16/395,311

(22) Filed: Apr. 26, 2019

(51) Int. Cl. A47J 36/24; A47J 36/32

(52) U.S. Cl. CPC A47J 36/2433; A47J 36/32

(57) ABSTRACT

A warming apparatus for warming baby food, including milk and other liquid or semi-liquid beverages, is disclosed. The present invention provides an apparatus including a main body having a UV-C light emitting diode, a cover, and a printed circuit board (PCB); and a heating rod having a temperature regulator, an external sensor, and an internal sensor, all at a lower tip of the heating rod. The PCB further includes a micro-controller configured to generate a plurality of control signals for controlling the temperature regulator, and to receive a plurality of sensing signals from the external sensor and the internal sensor. The heating rod is enclosed within a cavity covered by the cover when the cover is properly attached to the main body when the temperature regulator is not enabled.

### FIELD OF THE INVENTION

The present invention relates to a portable baby food warmer and, more particularly, to a heating rod for warming milk and other baby food in a baby bottle.

### BACKGROUND

Babies and young infants are commonly fed with milk (formula milk or breast milk) or other baby food from a bottle. Freshly expressed breast milk can usually be stored in a refrigerator for a few days, or in a freezer for a more extended period. To prepare the refrigerated milk for use, it is necessary to warm the milk to a temperature that is close to body temperature, i.e., around 37° C. If the milk is too cold, the baby may refuse to drink the milk or may be in some discomfort when consuming the milk. If the milk is too hot, the baby may be injured and the nutritional value may be affected.

There are several ways to warm a bottle of milk, such as running warm water over the bottle, or using a baby bottle warmer. A typical example of a baby bottle warmer is U.S. Pat. No. 8,045,848 B2, which has a vessel to hold water and the milk bottle, and a heating element for heating the water held in the vessel.

The problem with the conventional baby bottle warmers is the size of the device, which has a width at least larger than the width of the milk bottle in order to immerse the milk bottle therein. As the size of the milk bottle varies, for example, a Medela™ breast milk bottle has a width of about 2.4 inches, while a Tommee Tippee™ baby bottle has a width of about 3.2 inches, the size of the baby bottle warmer cannot be too small or otherwise some of the baby bottles cannot fit into the device. Therefore, the inconsistency in the size of baby bottles creates inconveniences to parents, and the bulkiness of the existing designs of baby bottle warmer prevents the warmer from being carried around and used outside of the home.

Furthermore, baby bottle warmers are generally powered by an alternating current (AC) power source, and there is the need that such a power source being available for warming the milk. It is not conventional to have a baby bottle warmer operable as a portable device while maintaining sufficient output power to warm the milk efficiently.

Accordingly, there is a need in the art to have a warmer comprising a heating rod, which can warm the baby food in a baby bottle. Particularly, the baby food warmer is operable as a portable device, and the heating rod is immersed into the baby food in a baby bottle for delivering heat thereto without the use of an AC power source.

### SUMMARY OF THE INVENTION

It is an object of the present disclosure to provide a portable baby food warmer for warming milk and other baby food in a baby bottle.

In accordance with certain embodiments of the present disclosure, a warming apparatus comprises a main body comprising a UV-C light emitting diode, a cover, and a printed circuit board (PCB); and a heating rod comprising a temperature regulator, an external sensor, and an internal sensor, all at a lower tip of the heating rod. The PCB further comprises a micro-controller configured to generate a plurality of control signals for controlling the temperature regulator, and to receive a plurality of sensing signals from the external sensor and the internal sensor; and the heating rod is enclosed within a cavity covered by the cover when the cover is properly attached to the main body when the temperature regulator is not enabled.

In accordance with a further aspect of the present disclosure, the UV-C light emitting diode is switched on when the cover is attached to the main body for sterilization and disinfection of the heating rod.

In accordance with a further aspect of the present disclosure, the micro-controller is configured to identify a deviation of temperature between the sensing signals from the external sensor and from the internal sensor for determining whether the temperature regulator is operating without immersing into the baby food.

In accordance with a further aspect of the present disclosure, the external sensor is positioned at the lower tip facing outwardly for measuring the temperature of the baby food.

In accordance with a further aspect of the present disclosure, the internal sensor is positioned in the lower tip proximate to the temperature regulator for measuring the temperature of the temperature regulator.

In accordance with a further aspect of the present disclosure, the main body further comprises a one or more high power batteries; and the temperature regulator is electrically powered by the one or more high power batteries. The high power batteries have an output power more than 50 W, and are rechargeable lithium-ion batteries, lithium polymer batteries, or other rechargeable batteries, for providing electrical power to the temperature regulator.

In accordance with a further aspect of the present disclosure, the main body further comprises an LCD and one or more control switches.

In accordance with a further aspect of the present disclosure, the apparatus further comprises an extension switch and a hinged joint pivotally connecting the heating rod to the main body about a pivot axis, wherein the extension switch actuates the hinge joint to turn the heating rod away from the main body with a predetermined angle.

In accordance with a further aspect of the present disclosure, the apparatus further comprises a flexible cable connecting the heating rod to the main body.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects of the present invention are disclosed as illustrated by the embodiments hereinafter.

### BRIEF DESCRIPTION OF THE DRAWINGS

The appended drawings, where like reference numerals refer to identical or functionally similar elements, contain figures of certain embodiments to further illustrate and clarify various aspects, advantages and features of the baby food warmer as disclosed herein. It will be appreciated that these drawings and graphs depict only certain embodiments of the invention and are not intended to limit its scope. The baby food warmer as disclosed herein will be described and explained with additional specificity and detail through the use of the accompanying drawings in which:

FIG. 1 is a system block diagram for the baby food warmer in accordance with an exemplary embodiment of the present disclosure.

FIG. 2 is a front perspective view of the baby food warmer in accordance with an exemplary embodiment of the present disclosure.

FIG. 3 is a back perspective view of the baby food warmer of FIG. 2.

FIG. 4 is a front perspective view of the baby food warmer of FIG. 2 when the cover is disconnected.

FIG. 5 is a back perspective view of the baby food warmer of FIG. 2 showing the internal structure of the heating rod when the cover is disconnected.

FIG. 6 is an internal perspective view of the baby food warmer of FIG. 2.

FIG. 7 is a series of 3 drawings demonstrating the operation of the baby food warmer of FIG. 1.

FIG. 8 illustrates the use of the baby food warmer of FIG. 2 for charging other electronic devices.

FIG. 9 is a front perspective view of the baby food warmer in accordance with an exemplary embodiment of the present disclosure.

FIG. 10 is a front perspective view of the baby food warmer of FIG. 9 when the cover is opened.

FIG. 11 is a front perspective view of the baby food warmer of FIG. 9 when the heating rod is loosened.

FIG. 12 is a front perspective view of the baby food warmer of FIG. 9 when the heating rod is immersed into a bottle of baby food.

FIG. 13 illustrates the use of the baby food warmer of FIG. 9 for charging other electronic devices.

FIG. 14 is an internal perspective view of the baby food warmer of FIG. 9.

FIG. 15 is a graph showing the temperature of the internal sensor and the external sensor, when the baby food warmer is operating from 20° C.

FIG. 16 is a graph showing the temperature of the internal sensor and the external sensor, when the baby food warmer is idle operating.

FIG. 17 is a graph showing the temperature of the internal sensor and the external sensor, when the baby food warmer is operating from 60° C.

Skilled artisans will appreciate that elements in the figures are illustrated for simplicity and clarity and have not necessarily been depicted to scale.

### DETAILED DESCRIPTION

The present disclosure generally relates to an apparatus which can warm milk and other baby food in a baby bottle. More specifically, but without limitation, the present disclosure relates to a baby food warmer operable as a portable device which can conveniently increase the temperature of milk and other baby food without using an alternating current (AC) power source.

The following detailed description, the baby food warmer is merely exemplary in nature and is not intended to limit the disclosure or its application and/or uses. It should be appreciated that a vast number of variations exist. The detailed description will enable those of ordinary skill in the art to implement an exemplary embodiment of the present disclosure without undue experimentation, and it is understood that various changes or modifications may be made in the function and arrangement of the device of operation described in the exemplary embodiment without departing from the scope of the present disclosure as set forth in the appended claims.

Throughout the specification, milk includes both formula milk and breast milk. Baby food is typically referred to other liquid or semi-liquid dairy products, juice, cereal or other beverages, particularly for babies or infants. The present disclosure is suitable for heating liquid or beverages in a container, a baby bottle, or a bowl, typically between 50 ml and 500 ml. For simplicity, milk and baby food are generally referred to as “food content” in the present disclosure.

The term “micro-controller” or “MCU” as used herein may be formed as one or more digital signal processors (DSPs), general purpose microprocessors, application specific integrated circuits (ASICs), field programmable logic arrays (FPGAs), programmable I/O devices, or other equivalent integrated or discrete logic circuitry.

The term “ultraviolet C”, or the abbreviation “UV-C”, is used to refer to one type of ultraviolet light having a wavelength from 200 nm to 280 nm. Use of ultraviolet (UV) light, in particular, UV-C light, for sterilization and disinfection is well known. UV light at sufficiently short wavelengths is mutagenic to bacteria, viruses and other micro-organisms. Particularly at a wavelength of 254 nm, UV breaks the molecular bonds within micro-organismal DNA, producing thymine dimers in the DNA, thereby destroying the organisms, rendering them harmless or prohibiting growth and reproduction. UV-C radiation also attacks the vital DNA of the bacteria directly. The bacteria lose their reproductive capability and are destroyed. Parasites such as Cryptosporidia or giardia, which are extremely resistant to chemical disinfectants, are also efficiently reduced by UV-C.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Furthermore, the term “about”, when used in conjunction with a numerical value or range of values, refers preferably to a range that is within 10 percent, preferably within 5 percent, or more preferably within 1 percent of a value with which the term is associated. The use of any and all examples, or exemplary language (e.g., “such as”) provided herein, is intended merely to illuminate the invention better and does not pose a limitation on the scope of the invention unless otherwise claimed. No language in the specification should be construed as indicating any non-claimed element as essential to the practice of the invention.

Terms such as “upper”, “lower”, “inner”, “outer”, “front”, “rear”, and variations thereof herein are used for ease of description to explain the positioning of one element relative to a second element, and are not intended to be limiting to a specific orientation or position. Terms such as “first”, “second”, and variations thereof herein are used to describe various elements, regions, sections, etc. and are not intended to be limiting.

Terms such as “connected”, “in communication with”, and variations thereof herein are used broadly and encompass direct and indirect connections, and communication; and are not restricted to electrical, physical or mechanical attachments and connections.

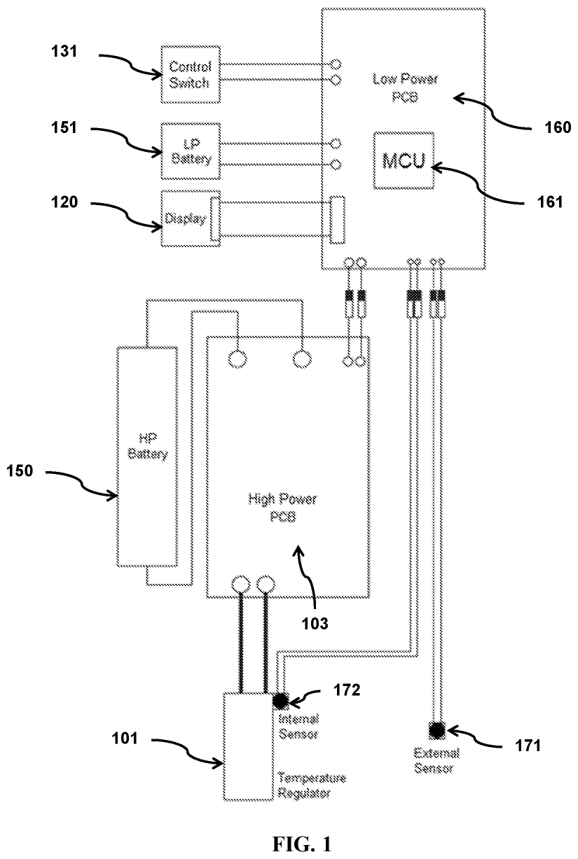

Now referring to FIG. 1, there is shown a system block diagram for the baby food warmer 10 in accordance with certain embodiments of the present disclosure. On the low power (LP) printed circuit board (PCB) 160, there provides a micro-controller 161 configured to receiving control signals from the control switches 131, receiving sensing signals from the internal sensor 172 and the external sensor 171, displaying status information on the liquid crystal display (LCD) 120, and controlling the temperature regulator 101. The control switches 131 can control the operation of the baby food warmer 10 and selecting the target temperature of the temperature regulator 101. On the high power PCB 103, there provides circuits configured receiving control signals from the micro-controller 161 and controlling the temperature regulator 101, which is powered by one or more high power batteries 150. In certain embodiments, the high power PCB 103 may comprise one or more micro-controller for controlling the temperature regulator 101. The low power PCB 160 can be powered by a low power battery 151, or by the high power battery 150 after coupling through a voltage regulator or filter. Therefore, the low power battery 151 and the high power battery 150 are physically separated. The low power PCB 160 and the high power PCB 103 are also physically separated and only electrically connected via a plurality of designated control signals. In particular, the power layer and ground layer of the low power PCB 160 and the high power PCB 130 are not connected together. The high power PCB 103 is used to drive the temperature regulator 101, which may involve higher transient voltages and high magnitude spikes. The low power PCB 160 and the components thereon are protected from damage by physical separation from the high power PCB 103 and using filters and other transient or noise suppression devices at the control signals.

When the temperature regulator 101 is configured to be disabled by toggling the control switches 131, the external sensor 171 can also be used to measure the temperature of the food content accurately. The measured temperature can be shown on the LCD 120.

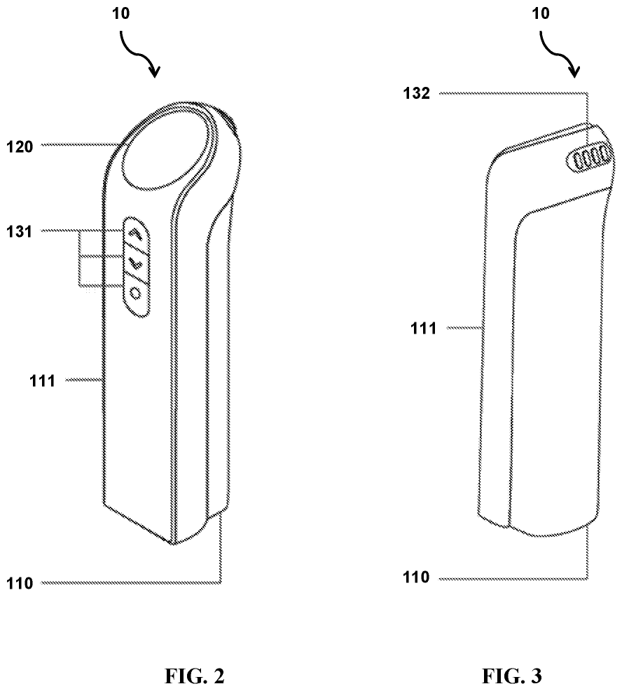

The system of FIG. 1 can be implemented as a portable heating device having a variety of mechanical structures for warming the food content. FIGS. 2 and 3 illustrate a front and a back perspective view of an exemplary implementation of the baby food warmer 10 in accordance with the present disclosure. The baby food warmer 10 comprises a main body 111 and a detachable cover 110, wherein the main body 111 comprises a LCD 120 at the top of the main body 111, an extension switch 132, and one or more control switches 131. The control switches 131 can be used as a power switch and a selection switch for selecting the mode of operation. The LCD 120 shows information on the status of the baby food warmer 10.

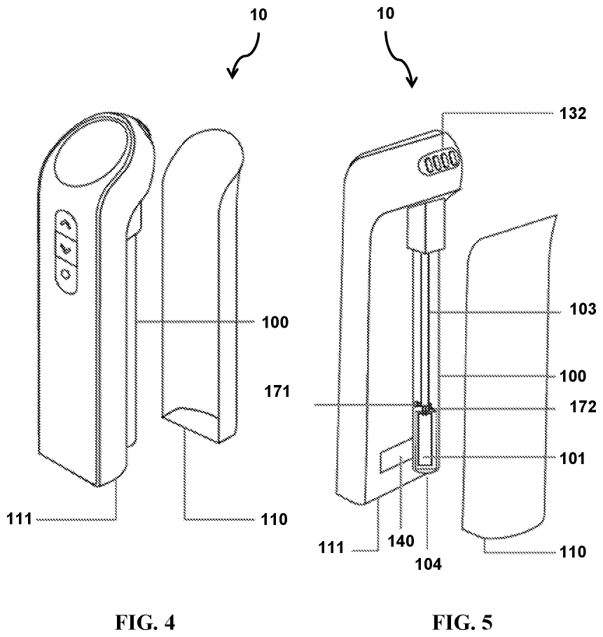

Referring to FIGS. 4 and 5, the back of the main body 111 is depicted after removing the detachable cover 110. The main body 111 further comprises a heating rod 100 and an UV-C light emitting diode 140 at the back of the main body 111 and enclosed within the cavity covered by the detachable cover 110 when the detachable cover 110 is properly attached to the main body 111 when the temperature regulator 101 is not enabled, as demonstrated in FIGS. 2 and 3. The UV-C light emitting diode 140 is only switched on when the detachable cover 110 is properly attached to the main body 111. The UV-C light emitting diode 140 is a proven method for sterilization and disinfection, and is switched on for a predetermined period to sterilize the baby food warmer 10. As shown in FIG. 5, the heating rod 100 further comprises a high power PCB 103, an external sensor 171, an internal sensor 172, and a temperature regulator 101. The high power PCB 103 is a PCB inside the heating rod 100 or nearby for routing electronic connections to the temperature regulator 101. The high power PCB 103 is designed to operate at a relatively higher current than the low power PCB 160. The power of the high power PCB 103 is preferably more than 50 W for driving the temperature regulator 101. In certain embodiments, the high power PCB 103 may comprise one or more micro-controller for controlling the temperature regulator 101, an electronic relay or a power switch. As the heating rod 100 is immersed into the food content in a baby bottle, the temperature regulator 101 is positioned at the lower tip 134 of the heating rod 100 for enhancing heat transfer to the food content, but may also be located anywhere in the vicinity. The temperature regulator 101 creates heat that causes the temperature of the surrounding walls around the lower tip 104 to rise, which in turn causes heat transfer to the food content which is directly in contact with the lower tip 104. The external sensor 171 is positioned anywhere at the lower tip 134 facing outwardly towards the surrounding wall of the lower tip 104, while the internal sensor 172 is also positioned in the lower tip 104 proximate to the temperature regulator 101 for accurately measuring the temperature thereof

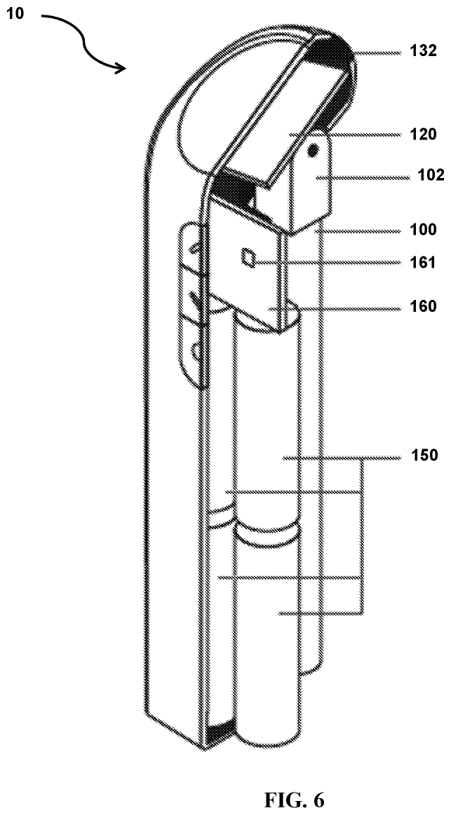

FIG. 6 illustrates an internal structure of the baby food warmer 10. As shown, the baby food warmer 10 comprises a hinge joint 102 pivotally connecting the heating rod 100 to the main body 111 about a pivot axis, a low power PCB 160, and one or more high power batteries 150. The low power PCB 160 further comprises a micro-controller 161. The high power battery 150 is a rechargeable lithium-ion battery, lithium polymer battery, or other rechargeable batteries, for providing electrical power to the temperature regulator 101. Preferably, the one or more high power batteries 150 have an output power more than 50 W.

The low power PCB 160 is designed to operate at a relatively lower current than the high power PCB 103 in the heating rod 100. The power of the low power PCB 160 is preferably less than 5 W. The micro-controller 161 is an electronic device configured to generate a plurality of control signals for controlling the LCD 120 and the temperature regulator 101, to receive a plurality of sensing signals from the external sensor 171 and the internal sensor 172; and to perform analysis thereof The micro-controller 161 can also monitor the status of the baby food warmer 10 for detecting any abnormality of operation. The control signals for the temperature regulator 101, internal sensor 172, and external sensor 171 are routed to the high power PCB 103 in the heating rod 100. At the bottom of the main body 111, there is provided a charging connector for connecting to a USB cable to charge the baby food warmer 10. For convenience and simplicity, the charging connector and the respective electronic parts have not been shown in the figures.

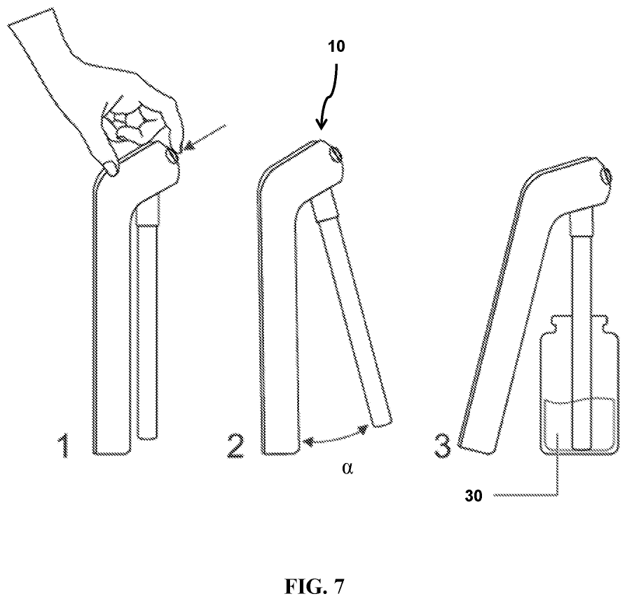

FIG. 7 shows the typical operation of the baby food warmer 10 for warming the food content 30 in a baby bottle. The extension switch 132 actuates the hinge joint 102 to turn the heating rod 100 away from the main body 111 with a predetermined angle a. Preferably, the angle a is in not more than 60 degrees so that the baby food warmer 10 can stand properly. After turning the heating rod 100 by the angle a, the main body 111 and the heating rod 100 can stand with a sharp of an inverted “V” as shown in FIG. 7. The heating rod 100 can be immersed into the baby bottle and the baby food warmer 10 can stand by itself

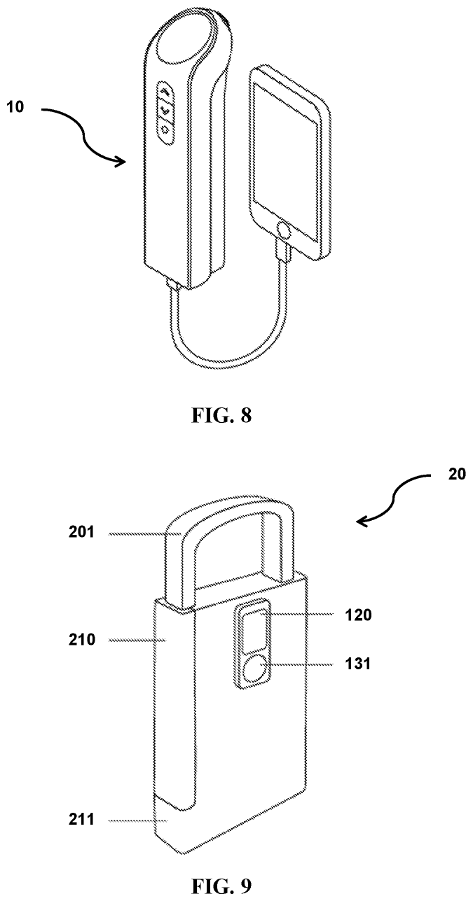

As shown in FIG. 8, the baby food warmer 10 can also be used as a portable battery for charging other electronic devices.

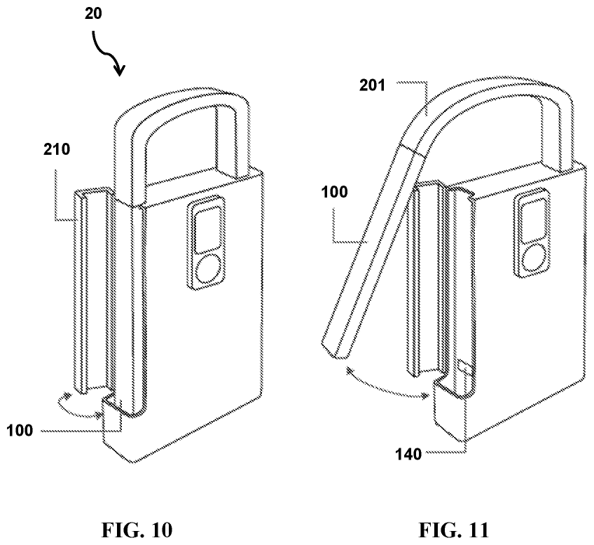

The system of FIG. 1 can also be used in an alternative design of the baby food warmer 20. As shown in FIG. 9, the structure of the baby food warmer 20 is depicted, which is similar to a closed lock formed by a flexible cable 201 with a sharp of an inverted “U” and a main body 211. The main body 211 further comprises a LCD 120 and one or more switches 131. On the longitudinal side of the main body 211, there is provided a hinged cover 210 for covering the heating rod 100 (not shown in FIG. 10), which is enclosed within the cavity covered by the hinged cover 210 when the hinged cover 210 is properly attached to the main body 211 when the temperature regulator 101 in the heating rod 100 is not enabled.

Referring to FIGS. 10-11, the baby food warmer 20 is further depicted when the hinged cover 210 is opened. As shown in the FIG. 11, the heating rod 100 is connected to the main body 211 by the flexible cable 201. Behind the heating rod 100, there is an UV-C light emitting diode 140 for sterilization and disinfection of the heating rod 100. The UV-C light emitting diode 140 is only switched on when the heating rod 100 is properly stored inside the hinged cover 210.

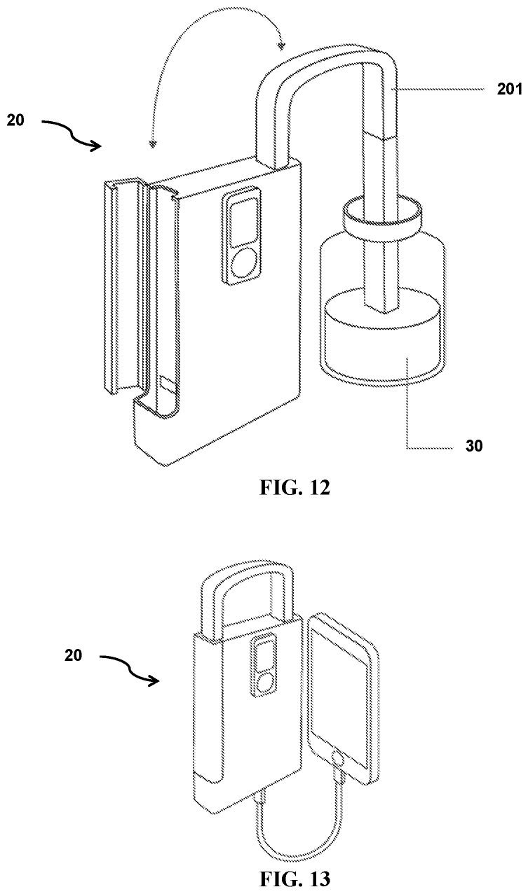

FIG. 12 shows the typical operation of the baby food warmer 20 for warming the food content 30 in a baby bottle. In the example shown, the flexible cable 201 is flipped by 180 degrees to another side of the baby food warmer 20 transversely. The heating rod 100 can then be immersed into the baby bottle for heating the food content 30. The flexible cable 201 can also be flipped to other directions freely and the baby bottle is not necessarily placed at the position shown in FIG. 12.

As shown in FIG. 13, the baby food warmer 20 can also be used as a portable battery for charging other electronic devices.

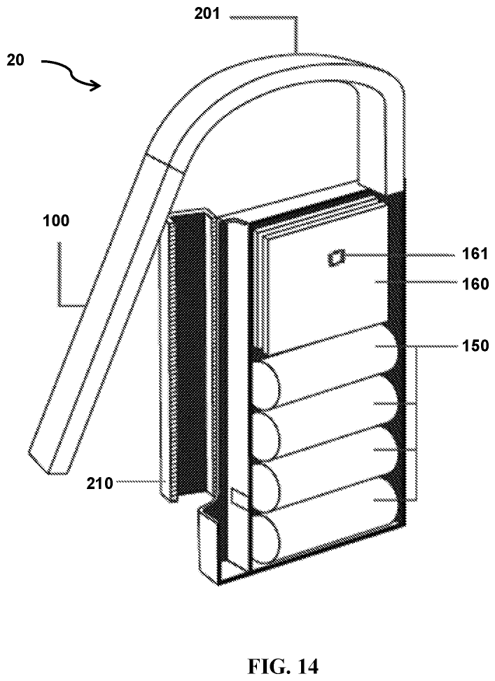

FIG. 14 illustrates an internal structure of the alternative design of the baby food warmer 20. As shown, the baby food warmer 20 comprises a heating rod 100, a flexible cable 201, a hinged cover 210, a low power PCB 160, and one or more high power batteries 150. The low power PCB 160 further comprises a low power battery (not shown in FIG. 14) and a micro-controller 161. The high power battery 150 is a rechargeable lithium-ion battery, lithium polymer battery, or other rechargeable batteries, for providing electrical power to the temperature regulator 101 inside the heating rod 100 (structure shown in FIG. 5). At the bottom or back of the main body 211, there is provided a charging connector for connecting to a USB cable to charge the baby food warmer 20. For convenience and simplicity, the charging connector and the respective electronic parts have not been shown in the figures.

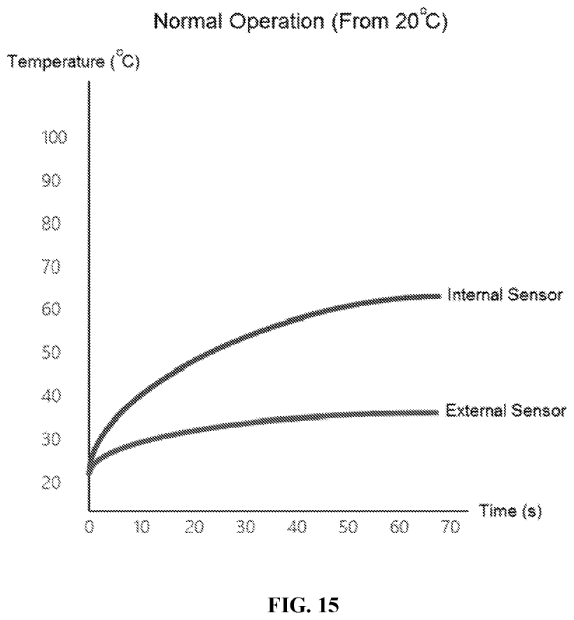

FIGS. 15-17 are the graphs showing the temperature of the internal sensor 172 and the external sensor 171 in various situations. Advantageous, the micro-controller 161 is programmed to execute analysis on the temperature measurements for determining the condition of the baby food warmer 10, 20, and the operation required. The purpose is to avoid the operation of the temperature regulator 101 at idle state, and decrease the power output when the temperature of the food content reaches the target temperature. As shown in FIG. 15, the temperature regulator 101 is switched on at time 0 while the food content and the temperature regulator 101 are at approximately 20° C. The measured temperature of the internal sensor 172 and the external sensor 171 increase gradually to about 60° C. and 37° C. respectively in one minute. The heat energy is first transferred to the food content around the lower tip 104, thereby transfers to the food content further away from the baby food warmer 10, 20. The external sensor 171 can measure the temperature of the food content around the lower tip 104, but not those further away. In order to ensure that a generally uniform heat distribution throughout the food content, the measurement for the external sensor 171 should be stable at the target temperature for a while.

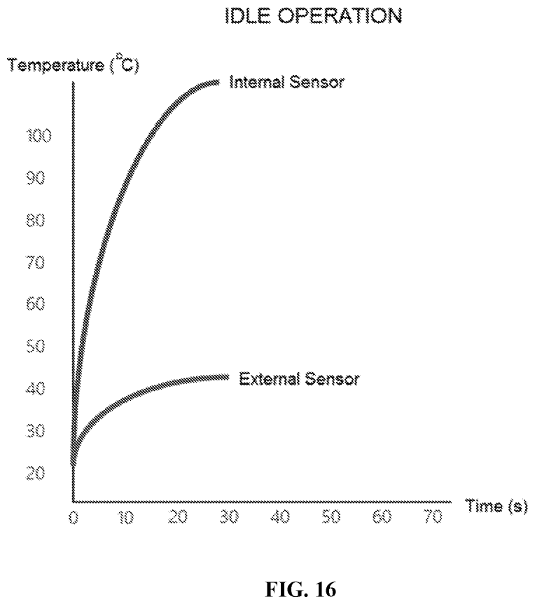

As shown in FIG. 16, the baby food warmer 10, 20 is not immersed into any food content while the temperature regulator 101 is switched on at time 0 with a temperature measurement of approximately 20° C. at the temperature regulator 101 and the surrounding air. Without water as the heat transfer medium, the temperature measurement of the internal sensor 172 is increased faster, and the temperature difference between the internal sensor 172 and the external sensor 171 is drastically large. This may potentially create a hazard situation to the user when the user touches the lower tip 104 of the baby food warmer 10, 20. Therefore, the micro-controller 161 is configured to identify an unusual temperature deviation between the sensing signals from the internal sensor 172 and from the external sensor 171, thereby to disable the temperature regulator 101 to avoid the idle operation of the baby food warmer 10, 20.

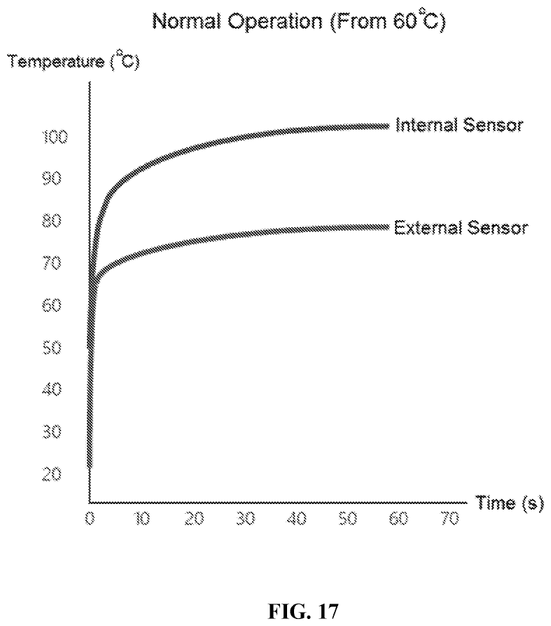

As shown in FIG. 17, the temperature regulator 101 is switched on at time 0 while the food content and the temperature regulator 101 are at approximately 60° C. The measured temperature of the internal sensor 172 and the external sensor 171 increase gradually to about 100° C. and 78° C. respectively in one minute.

The present disclosure may be embodied in other specific forms without departing from the spirit or essential characteristics thereof. The present embodiment is therefore to be considered in all respects as illustrative and not restrictive. The scope of the disclosure is indicated by the appended claims rather than by the foregoing description, and all changes that come within the meaning and range of equivalency of the claims are therefore intended to be embraced therein.

What is claimed is:

1. A warming apparatus for warming baby food, the apparatus comprising:
a main body comprising a UV-C light emitting diode, a cover, and a printed circuit board (PCB); and
a heating rod comprising a temperature regulator, an external sensor, and an internal sensor, all at a lower tip of the heating rod;
wherein:
the PCB further comprises a micro-controller configured to generate a plurality of control signals for controlling the temperature regulator, and to receive a plurality of sensing signals from the external sensor and the internal sensor; and
the heating rod is enclosed within a cavity covered by the cover when the cover is properly attached to the main body when the temperature regulator is not enabled.

2. The apparatus of claim 1, wherein the UV-C light emitting diode is switched on when the cover is attached to the main body for sterilization and disinfection of the heating rod.

3. The apparatus of claim 1, wherein the micro-controller is configured to identify a deviation of temperature between the sensing signals from the external sensor and from the internal sensor for determining whether the temperature regulator is operating without immersing into the baby food.

4. The apparatus of claim 3, wherein the external sensor is positioned at the lower tip facing outwardly for measuring the temperature of the baby food.

5. The apparatus of claim 3, wherein the internal sensor is positioned in the lower tip proximate to the temperature regulator for measuring the temperature of the temperature regulator.

6. The apparatus of claim 1, wherein the main body further comprises a one or more high power batteries, wherein the one or more high power batteries is used to electrically power the temperature regulator.

7. The apparatus of claim 6, wherein the one or more high power batteries have an output power more than 50 W.

8. The apparatus of claim 6, wherein the one or more high power batteries are rechargeable lithium-ion batteries, lithium polymer batteries, or other rechargeable batteries, for providing electrical power to the temperature regulator.

9. The apparatus of claim 1, wherein the main body further comprises an LCD and one or more control switches.

10. The apparatus of claim 1 further comprising an extension switch and a hinged joint pivotally connecting the heating rod to the main body about a pivot axis, wherein the extension switch actuates the hinge joint to turn the heating rod away from the main body with a predetermined angle.

11. The apparatus of claim 1 further comprising a flexible cable connecting the heating rod to the main body.
